(19) United States
(12) Patent Application Publication
(10) Pub. No.: US 2005/0184561 A1
(43) Pub. Date: Aug. 25, 2005

(54) Method of manufacture of a chromogenic panel

(76) Inventor: John Martino, Lenox, MA (US)

Correspondence Address: MALCOLM J. CHISHOLM, JR.;ATTORNEY AT LAW, P. O. BOX 278, 220 MAIN STREET, LEE, MA, 01238, US

(21) Appl. No.: 11/060,341

(22) Filed: Feb. 17, 2005

Related U.S. Application Data
(60) Provisional application No. 60/546,496, filed on Feb. 20, 2004.

(51) Int. Cl. B60J 7/00; B60R 13/07; B62D 25/06; B62D 25/07

(52) U.S. Cl. 296/211

(57) ABSTRACT

An improved method of manufacture of a chromogenic panel (10) includes the steps of securing a chromogenic matrix (20) between conductive surfaces (14, 18) of first and second substrates (12, 16) to form a chromogenic film (23); applying a partial vacuum through a plurality of throughbores (28) in a flat cutting surface (24) to secure the film (23) to the cutting surface (24); and using a laser beam (40) to cut a perimeter edge (22), bus-bar cut-outs (54, 62), or an image field line (75) within the substrates (12, 16) to form and manufacture the chromogenic panel (10). The partial vacuum applied through the flat cutting surface (24) provides for an exceptionally flat cutting surface of the panel (10) to facilitate precise focus and cutting by the laser beam (40).

### CROSS REFERENCE TO RELATED APPLICATION

This Application claims the benefit of U.S. Provisional Patent Application Ser. No. 60/546,496 that was filed on Feb. 20, 2004, entitled “Method of Manufacture of a Chromogenic Panel”.

### TECHNICAL FIELD

The present invention relates to chromogenic panels that provide varying optical properties in response to varying electrical signals, and especially relates to an improved method of manufacture of a chromogenic panel.

### BACKGROUND ART

Chromogenic panels are well known for providing varying optical properties in response to varying electrical or other signals, as disclosed for example in U.S. Pat. No. 6,039,390 that issued on Mar. 21, 2000 for a “Chromogenic Window Assembly Construction and Other Chromogenic Devices”. As shown in FIG. 1, a typical chromogenic panel generally designated by the reference numeral 10 includes a first substrate 12 having a first electrically conductive surface 14, a second substrate 16 having a second electrically conductive surface 18, and a chromogenic matrix 20 secured between the first and second substrates 12, 16 and secured in electrical communication with the first and second conductive surfaces 14, 18. The substrates 12, 16 are typically a light transmitting substance, such as glass, polycarbonates, etc., and in some embodiments one substrate may have optical properties distinct from the other substrate. The first and second electrically conductive surfaces 14, 18 are typically thin metal coatings, or other electrically conductive surfaces known in the art.

The chromogenic matrix may be any of the well known chromogenic particles supported so that the particles move generally in unison in response to electrical current signals or other energy signals, such as suspended particles, liquid crystals, polymer assembled liquid crystals, or any other known material that provides for varying optical properties in response to varying electrical or other energy signals. As is known, the chromogenic matrix contains light valve cells used to restrict or diffuse (non-energized) light passage through the panel, or to allow passage of light through the panel, thereby restricting or allowing vision through the panel.

In manufacturing chromogenic panels, the chromogenic matrix 20 is usually applied as a coating between the electrically conductive surfaces 14, 18, and effectively restricts direct electric current flow between the conductive surfaces 14, 18, so that any electric current must flow through the matrix 20. As is known in the art, electric current flow between the first and second electrically conductive surfaces 14, 18 may be varied to alter optical properties of the chromogenic matrix 20, such as to reduce or increase light transmission or visibility through the chromogenic panel 20.

Securing the chromogenic matrix 20 between the substrates 12, 16 produces a chromogenic film 23 that must be cut to a desired size to form the chromogenic panel 10. Because chromogenic panels are manufactured to be as thin as possible, cutting a chromogenic film 23 into a desired size presents substantial difficulties. Known cutting methods include razors or sharp knives mounted to machinery, or hand-held razors or similar cutters that cut a chromogenic film 23 to define a perimeter edge 22. Such cutting methods, however, frequently generate microscopic hairs of electrically conductive material crossing directly between the first and second conductive surfaces 14, 18 that effectively short-circuit flow of current between the conductive surfaces 14, 18 impairing performance of the panel 10. Additionally, such cutting methods are very labor intensive, time consuming, and result in significant challenges in consistently cutting the film to desired tolerances. Frequently, precise tolerances simply cannot be achieved.

Once the perimeter edge 22 has been defined by cutting the chromogenic panel 10 from a film, it is then necessary to cut a portion of each substrate 12, 16 away from the panel 10 to provide for connection of an electrical current transmitting bus bar assembly, as is known in the art. Cutting a bus bar connector cut is perhaps the most critical step in providing for proper operation of the panel 10. Such a connector cut must cut sections of the substrates 12, 16 and their conductive surfaces 14, 18 adjacent the perimeter edge 22 while not removing adjacent portions of the opposed conductive surfaces 14, 18. Typically, a cutting tool, such as a knife or razor is inserted between the conductive surfaces 14, 16 and the adjacent chromogenic matrix 20 to separate them, and the connector cut is made in the substrate 12 to remove portions of the substrate 12 and conductive surface 14 between the perimeter edge 22 and a connector cut line. If opposed conductive surfaces 14, 18 are cut or scored during this sensitive operation, the chromogenic panel 10 may fail or provide unacceptable performance.

As is apparent, known cutting methods are time consuming, labor intensive, and give rise to significant quality concerns. Cutting blades must be regularly sharpened, etc, and the skill of a person cutting the film is critical to consistent performance. Accordingly, there is a need for an improved method of manufacture of chromogenic panels.

### SUMMARY OF THE INVENTION

The invention is a method of manufacturing a chromogenic panel including the steps of securing at least one chromogenic matrix layer between a first electrically conductive surface of a first substrate and a second electrically conductive surface of a second substrate to form a chromogenic film. Next, a partial vacuum is applied through a plurality of throughbores defined within a flat cutting surface to secure the chromogenic film to the flat cutting surface. A laser beam is applied to cut a perimeter edge of the chromogenic film along a predetermined perimeter edge of the film to form the chromogenic panel, wherein the laser beam is applied at an energy level adequate to cut through the first and second substrates and chromogenic matrix without melting the substrates or chromogenic matrix. Additionally, the laser beam is applied to the chromogenic film at a rate of speed across the film sufficient to prevent accumulation of heat within the film adequate to melt the substrates or chromogenic matrix.

In a preferred method, the vacuum is applied through the plurality of throughbores defined within the flat cutting surface to secure the chromogenic film to the flat cutting surface wherein the throughbores are no greater than one-sixteenth of an inch in diameter and are dispersed no closer than about three-quarters of an inch from each other.

The invention also includes applying the partial vacuum through the throughbores to secure the chromogenic panel in a flat disposition while applying a laser beam to remove a first bus-bar cut-out of the first substrate and the electrically conductive surface adjacent the first substrate at a perimeter edge of the panel so that the first bus-bar cut-out contacts a first side of a through cut of the chromogenic panel. The laser beam is also used to remove a second bus-bar cut-out of the second substrate and the electrically conductive surface adjacent the second bus-bar cut-out at the perimeter edge of the panel so that the second bus-bar cut-out contacts a second side of the through cut opposed to the first side of the through cut. The laser beam is applied using only enough energy to cut through the substrates and their adjacent conductive surfaces but not with enough energy to cut through the chromogenic matrix or conductive surfaces adjacent opposed sides of the chromogenic matrix. A bus bar assembly may then be secured to the first and second bus-bar cut-outs to apply electrical current to the chromogenic matrix to thereby vary optical characteristics of the chromogenic matrix.

A preferred method also includes applying the partial vacuum to the chromogenic panel and applying a laser beam to the panel to cut a path along a predetermined image field line to define an image field, wherein the laser beam applies only enough energy to cut through the first substrate and the electrically conductive surface of the first substrate but not enough to cut through the chromogenic matrix. That permits an image field bus bar to be secured in electrical communication with the electrically conductive surface within the image field to vary optical characteristics of the chromogenic matrix within the image field compared to optical characteristics of the chromogenic matrix outside of the image field.

By using the partial vacuum to secure the chromogenic panel in an especially flat disposition, the laser beam may be utilized to make precise cuts of perimeter edges of the panel, of bus-bar cut-outs, and of image field lines so that the resulting chromogenic panel may be manufactured with precision and efficiency unknown in the prior art. Additionally, the vacuum also serves to remove from the cutting surface any vaporized material or cut debris to further minimize any risk of contamination of the laser cut throughs of the chromogenic panel. The flat cutting surface through which the partial vacuum is applied has no variations within a plane of the surface that are greater than plus or minus one-fiftieth of an inch. Use of the flat cutting surface and partial vacuum therefore facilitates a precise and continuous focusing of the laser beam at a desired point and to a desired depth through and within the chromogenic panel to efficiently produce chromogenic panels of extraordinarily high quality.

Accordingly, it is a primary object of the present invention to provide a method of manufacturing a chromogenic panel that overcomes deficiencies of the prior art.

It is an additional object to provide a method of manufacturing a chromogenic panel that provides a precise cutting of a perimeter edges, bus-bar cut-outs and image field lines of the panel.

It is an additional object to provide a method of manufacturing a chromogenic panel that minimizes risks of contamination of cuts of the panel by debris generated during cutting of the chromogenic panel.

These and other objects and advantages of the present method of manufacturing a chromogenic panel will become more readily apparent when the following description is read in conjunction with the attached drawings.

### BRIEF DESCRIPTION OF THE DRAWINGS

FIG. 1 is an exploded, side view of a chromogenic panel 10 manufactured in accordance with the present invention.

FIG. 2 is a schematic, perspective view of the FIG. 1 chromogenic panel shown suspended over a flat cutting surface to which a vacuum is applied, showing a schematic representation of a laser cutting a perimeter edge of the chromogenic panel in accordance with the present invention.

FIG. 3 is a top plan view of a second chromogenic panel showing bus-bar cut-outs and a bus bar controller.

FIG. 4 is a top plan view of a third chromogenic panel showing bus-bar cut-outs and a through cut.

FIG. 5 is a top plan view of a fourth chromogenic panel having an image field.

### DESCRIPTION OF THE PREFERRED EMBODIMENTS

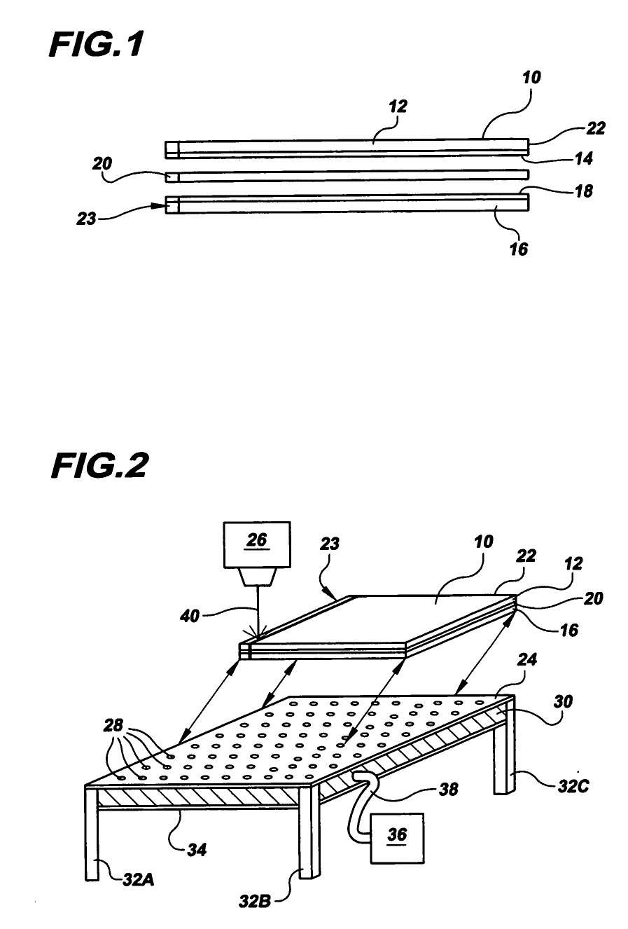

The invention is a method of manufacturing a chromogenic panel 10 that provides for varying optical characteristics in response to varying energy signals. The method comprises the steps of first securing at least one chromogenic matrix 20 between a first electrically conductive surface 14 of a first substrate 12 and a second electrically conductive 16 surface of a second substrate 18 to form a chromogenic film 23 as best shown in FIG. 1. Next, the chromogenic film 23 is secured to an especially flat cutting surface 24. It has been determined by the inventors herein that use of a laser 26 to cut the chromogenic panel 10 requires that the surface of the panel 10 being cut must be extremely flat. Therefore, a flat cutting surface 24 for purposes herein is defined to have no variations within a plane of the surface 24 that are greater than plus or minus one-fiftieth of an inch, or preferably, plus or minus one-hundredth of an inch.

The flat cutting surface 24 of the present invention includes a plurality of throughbores 28 to which a partial vacuum is applied in order to secure the chromogenic panel 10 to the flat cutting surface 24. The partial vacuum may be applied by any vacuum applying means for applying a vacuum between the chromogenic panel 10 and flat cutting surface 24, such as a vacuum box table 30 which consists of support legs 32A, 32B, 32C, a box 34 dimensioned to receive and support the flat cutting surface 24 and seal it against fluid transfer into the box 34 other than through the throughbores 28. A vacuum pump 36 may be utilized to apply a suction force through a vacuum hose 38 into the box 34 to apply the partial vacuum through the throughbores 28. As the laser 26 cuts the chromogenic film 23 to make the chromogenic panel 10, the partial vacuum applied to the panel 10 provides for an exceptionally flat disposition of the panel 10, especially at the perimeter edge 22, which is difficult to secure in a flat plane. This facilitates a precise and continuous focusing of the laser beam 40 at a desired point, and to a desired depth on and within the chromogenic panel 10. In a preferred embodiment, the plurality of throughbores 28 are no greater than about one-sixteenth of an inch in diameter, and are positioned no closer than about three-quarters of an inch from each other.

It is known in the art of laser cutting that vaporized material, such as portions of the substrates 12, 14 being cut, must be immediately exhausted away from the panel 10 being cut. By having the throughbores 28 and above-described partial vacuum system applying a partial vacuum to the surface of the panel 10 opposite to the surface being cut, a laser exhaust system or removal of vaporized material from the panel 10 may be accomplished without jeopardizing stable securing of the panel 10 to the smooth cutting surface 24. Therefore, the smooth cutting surface 24 with throughbores 28 through which a partial vacuum is applied to the chromogenic panel 10 provides for an exceedingly precise, flat surface of the panel 10 to facilitate precise and consistent cutting of the panel by the laser 26.

A preferred laser is available under the trade name “model FX35 CO₂ Laser” and sold by the Vytek Laser, Inc. company of Massachusetts. An optimal power setting of the beam strength for a perimeter cut is about 15 percent. An optimal power setting of the beam strength for a bus bar cut is about 5 percent. An optimal pen speed is about 2.90 inches per second. These settings are for a material thickness of about 0.14 inches of the material being cut by the laser, such as the first substrate 12 and first conductive surface 14. For purposes herein, the word “about” is to mean plus or minus 20 percent.

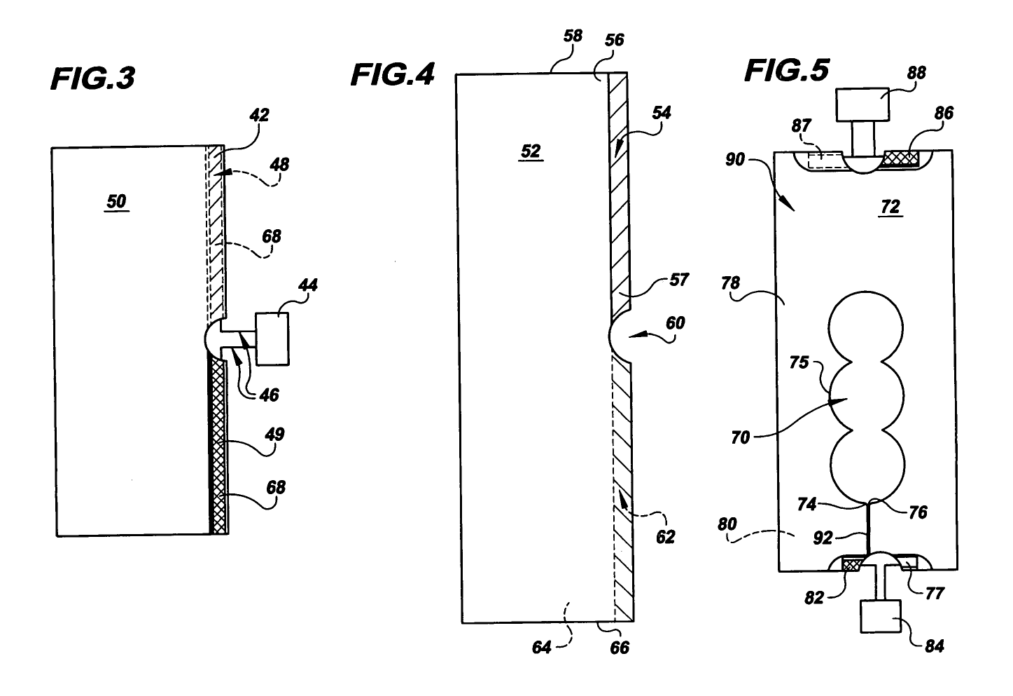

As shown in FIG. 3, the method of the present invention also includes securing a bus bar assembly 42 for directing electrical or other energy signals from a bus bar controller 44 through power wires 46 to a first bus-bar cut-out 48 and second bus-bar cut-out 49 of a second chromogenic panel 50. As seen best in FIG. 4 showing a third chromogenic panel 52, before securing such a bus bar assembly 42, a first bus-bar cut-out 54 is cut by the laser 26 that removes only a section of a first substrate 56 and its adjacent first electrically conductive surface of the third chromogenic panel 52. The first bus-bar cut-out 54 is made by the laser 26 applying only enough energy to cut through the first substrate 56 and its adjacent first electrically conductive surface, but not enough energy to cut through the chromogenic matrix 57 of the third panel 52. The first bus-bar cut-out 54 extends from a top edge 58 of the panel 52 to a through-cut 60 in the panel. The method includes making a second bus-bar cut-out 62 with the laser 26 that cuts a section of the second substrate 64 and its adjacent electrically conductive surface extending from the through cut 60 to an opposed bottom edge 66 of the third panel 52. The second substrate 64 is at a surface of the third chromogenic panel 52 opposed to the surface that includes the first substrate 56. The second bus-bar cut-out 62 is made by the laser 26 applying only enough energy to cut through the second substrate 64 and enough energy to cut through its adjacent electrically conductive surface, but not enough energy to cut through the chromogenic matrix 57 of the third chromogenic panel 52. For purposes herein, the phrase “cut through” with reference to the laser beam 40 means to both slice the identified object, and/or to vaporize the identified object. After the laser 26 has cut the first and second bus-bar cut-outs 54, 62, portions of the first substrate 56 and second substrate 64 and their electrically conductive surfaces within the first and second bus-bar cut-outs 54, 62 are removed.

As best shown in FIG. 3 with respect to the second chromogenic panel 50 having similar first and second bus-bar cut-outs 48 and 49 removed from the second chromogenic panel 50, the chromogenic matrix under each bus-bar cut-out 48, 49 is then removed. The chromogenic matrix may be removed by polishing the cut-outs 48, 49 with alcohol or other methods known in the art. Then, a conductive primer paint and an overlay of a conductive material, such as a copper foil tape 68, is applied to the first and second bus-bar cut-outs 48, 49 (shown in FIG. 3 over the second bus-bar cut-out 49). The power wires 46 are then secured to the copper foil tape 68 in both bus-bar cut-outs 48, 49 to form the bus bar assembly 42. The bus bar controller 44 then controls current flowing through the power wires 46, electrically conductive surfaces of the first and second substrates and chromogenic matrix of the second chromogenic panel 50 to produce a desired optical effect within the second chromogenic panel 50. The bus bar controller 44 may be any controller means known in the art for controlling optical characteristics of a chromogenic panel 50.

Because the laser 26 may be applied with such precision by securing the chromogenic panel 10 to the flat cutting surface 24, as shown in FIG. 2, the present invention also provides for forming an image field 70, shown in FIG. 5 in a fourth chromogenic panel 72. The image field 70 shown in FIG. 5 is in the form of three overlapping circles, or a partial “snowman form” as a potentially useful form. However, the image field may be in the form of any variety of images, such as logos for businesses, fanciful or artful shapes, etc. The image field 70 is formed by applying the laser beam 40 from an image field start point 74 of the fourth chromogenic panel 72 along a predetermined image field line 75 defined within a first substrate 78 of the fourth panel 72 and back to an image field end point 76, wherein the laser beam 40 applies only enough energy to cut through and remove about a 0.010 inch wide path of the first substrate 78 and its adjacent first electrically conductive surface, and not enough energy to remove a chromogenic matrix or a second substrate 80 of the fourth panel 72.

Next, an image field bus bar assembly 82 is secured to the fourth chromogenic panel 72 and in electrical communication with an image field bus bar controller 84 so that the image field bus bar assembly 82 is in electrical communication with the conductive surface 77 of the first substrate 78 within the image field 70 to control light transmission through or other optical characteristics of the image field 70. A protective cover sheet (not shown) may be secured over the image field line 75 to protect the chromogenic matrix 20 under the image line 75. The protective cover sheet 66 may consist of any materials known in the art that are compatible with the material characteristics and optical properties of the substrates 12, 16.

A non-image field bus bar assembly 86 may be secured to the fourth chromogenic panel 72 and in electrical communication with a non-image field bus bar controller 88 and an electrically conductive surface 87 of the second substrate 80 of the fourth panel 72 to control light transmission through or other optical characteristics of the non-image field 90 of the fourth chromogenic panel 72. The image field controller 84 and non-image field controller 88 may be separate controller means known in the art for controlling light transmission through chromogenic panels, or the controllers 84, 88 may be integrated as a single controller means for controlling light transmission through the image and non-image fields 70, 90, such as computerized controllers known in the art.

As shown in the fourth chromogenic panel 72 in FIG. 5, the image field bus bar assembly 82 and non-image field bus bar assembly 86 are constructed in a manner similar to the above description of the bus-bar cut-outs 48, 49 and 54, 62 of the second and third chromogenic panels 50, 52 of FIGS. 3 and 4. The invention includes the fourth chromogenic panel 72 having only an image field bus bar assembly 82 and controller 84, or only a non-image field bus bar assembly 86 and controller 88, depending upon special circumstances. A chromogenic panel of the present invention (not shown) may also include a plurality of image fields with separate image field controllers for each image field or with a single image field controller for the image fields. Additionally, the chromogenic panels 10, 50, 52, 72 may be manufactured in the above described manner with a plurality of adjacent and/or overlapping chromogenic matrices (not shown) and appropriate bus bar assemblies and controllers (not shown) to provide for an enhanced variety of optical characteristics.

The invention also includes the flat cutting surface 24 and laser apparatus 26 for manufacturing the chromogenic panel 10, wherein the flat cutting surface 24 includes the plurality of throughbores 28 defined within the flat cutting surface 24 and in fluid communication with the vacuum pump 36 for securing the chromogenic panel 10 to the flat cutting surface 24. The laser 26 is disposed so that the chromogenic panel 10 is secured between the flat cutting surface 24 and the laser 26 so that the laser 26 may project a laser beam 40 to the chromogenic panel 10 to cut through the chromogenic panel 10. The flat cutting surface 24 may be a component of a vacuum box table 30, described above, wherein the vacuum pump 36 applies a partial vacuum to a box 34 of the table 30 wherein the box 34 dimensioned to receive and support the flat cutting surface 24 and seal it against fluid transfer into the box 34 other than through the throughbores 28. The partial vacuum applies a suction to the plurality of throughbores 28 defined within the flat cutting surface 24. In a preferred embodiment, the throughbores 28 are defined to be no greater than about one-sixteenth of an inch in diameter, and are positioned no closer than about three-quarters of an inch from each other. Additionally, and as described above, the flat cutting surface 24 is defined to have no variations within a plane of the surface 24 that are greater than plus or minus about one-fiftieth of an inch, or preferably, plus or minus about one-hundredth of an inch.

As is apparent, the present method of manufacture of chromogenic panels 10, 50, 52, 72 provides for a reliable, consistent, and relatively easy manufacture of the panels. While the present invention has been disclosed with respect to the described and illustrated methods and embodiments, it is to be understood that the invention is not to be limited to those embodiments. For example, an image field (not shown) may be defined within the fourth panel 72 and not in communication with a perimeter edge of the panel, and in electrical communication with the image field bus bar 82 and controller 84 through alternative, known signal transmission means, including power wires 92, etc. Accordingly, reference should be made primarily to the following claims rather than the foregoing description to determine the scope of the invention.

1. A method of manufacturing a chromogenic panel (10), the method comprising the steps of:
a. securing at least one chromogenic matrix layer (20) between a first electrically conductive surface (14) of a first substrate (12) and a second electrically conductive surface (18) of a second substrate (16) to form a chromogenic film (23);
b. applying a partial vacuum through a plurality of throughbores (28) within a flat cutting surface (24) to secure the chromogenic film (23) to the flat cutting surface (24);
c. applying a laser beam (40) to the chromogenic (23) film to form the chromogenic panel (10) wherein the laser beam (40) is applied to the chromogenic film (23) at a rate of speed across the film (23) sufficient to prevent accumulation of heat within the film (23) adequate to melt the substrates (12, 16) or chromogenic matrix (20).

2. The method of claim 1, comprising the further step of cutting a perimeter edge (22) of the chromogenic film (23) during the applying the partial vacuum step, by applying the laser beam to cut through the chromogenic film (23) along a predetermined perimeter edge (22), wherein the laser beam (40) is applied at an energy level adequate to cut through the first and second substrates (12, 16) and chromogenic matrix (20) without melting the substrates (12, 16) or the chromogenic matrix (20).

3. The method of claim 1, comprising the further step of securing a bus bar assembly (42) to a perimeter edge (22) of the chromogenic panel (10) during the applying the partial vacuum step, by the steps of;
a. applying the laser beam (40) to remove a first bus-bar cut-out (54) of the first substrate (56) and an electrically conductive surface of the first substrate (54) to contact a first side of a through cut (60) of the chromogenic panel (52), wherein the laser beam (40) applies only enough energy to cut through the first substrate (56) and through the first conductive surface of the first substrate (56), but not enough energy to cut through the chromogenic matrix (20), the conductive surface of the second substrate (64) or the second substrate (64);
b. applying the laser beam (40) to remove a second bus-bar cut-out (62) of the second substrate (64) and an electrically conductive surface of the second substrate (64) to contact a second side of the through cut (60) opposed to the first side of the through cut (60) of the panel (52), wherein the laser beam (40) applies only enough energy to cut through the second substrate (64) and through the conductive surface of the second substrate (64), but not enough energy to cut through the chromogenic matrix (20), conductive surface of the first substrate (56), or the first substrate (56); and,
c. securing the bus bar assembly (42) to the conductive surface of the first substrate (56) and the conductive surface of the second substrate (64) on opposed sides of the through cut (60).

4. The method of claim 1, comprising the further step of forming an image field (70) in the chromogenic panel (72) during the applying the partial vacuum step, by the steps of;
a. applying a laser beam (40) from an image field start point (74) of the chromogenic panel (72) along a predetermined image field line (75) defined within the first substrate (78) and back to an image field end point (76) of the panel (72), wherein the laser beam (40) applies only enough energy to cut through and remove the first substrate (78) and the conductive surface of the first substrate (78), and not enough energy to remove the chromogenic matrix (20) or the second substrate (80);
b. securing an image field bus bar assembly (82) to the chromogenic panel (72) in electrical communication with the image field start point (74) and the image field end point (76) so that the bus bar assembly (82) is in electrical communication with the conductive surface of the first substrate (78) within the image field (70) defined within the panel (72) to control optical characteristics of the image field (70) of the panel (72).

5. The method of claim 4, comprising the further step of securing a non-image field bus bar assembly (86) to the chromogenic panel (72) in electrical communication with a non-image field (90) of the panel (72) to control optical characteristics of the non-image field (90) of the panel (72).

6. The method of claim 4, comprising the further step of applying a protective cover sheet over the image field line (75) to protect the chromogenic matrix (20) under the image line (75).

7. The method of claim 4, comprising the further step of applying the laser beam (40) along the image field line (75) with only enough energy to cut through and remove about a 0.010 inch wide path in the first substrate (78).

8. The method of claim 1, comprising the further step of defining the throughbores (28) within the flat cutting surface (24) so that the throughbores (28) are no greater than one-sixteenth of an inch in diameter and are dispersed no closer than about three-quarters of an inch from each other.

9. The method of claim 1, comprising the further step of defining the flat cutting surface (24) so that the flat cutting surface (24) has no variations within a plane of the flat cutting surface (24) greater than about plus or minus one-hundredth of and inch.

10. The method of claim 3, comprising the further step of forming an image field in the chromogenic panel by the steps of:
a. applying a laser beam (40) from an image field start point (74) of the chromogenic panel (72) along a predetermined image field line (75) defined within the first substrate (78) and back to an image field end point (76) of the panel (72), wherein the laser beam (40) applies only enough energy to cut through and remove about a 0.010 inch wide path in the first substrate (78) and the conductive surface of the first substrate (78), and not enough energy to remove the chromogenic matrix (20) or the second substrate (80);
b. securing an image field bus bar assembly (82) to the chromogenic panel (72) in electrical communication with the image field start point (74) and the image field end point (76) so that the bus bar assembly (82) is in electrical communication with the conductive surface of the first substrate (78) within the image field (70) defined within the panel (72) to control optical characteristics of the image field (70) of the panel (72).

11. A flat cutting surface (24) and laser (26) apparatus for manufacturing a chromogenic panel (10), the apparatus comprising a flat cutting surface (24) defining a plurality of throughbores (28) in fluid communication with a vacuum pump (36) applying means for applying a vacuum through the throughbores (28) for securing the chromogenic panel (10) to the flat cutting surface (24) by application of a partial vacuum through the throughbores (28), the laser (26) being disposed so that the chromogenic panel (10) is secured between the flat cutting surface (24) and the laser (26) so that the laser (26) may project a laser beam (40) to the chromogenic panel (10) to cut through the chromogenic panel (10).

12. The flat cutting surface (24) and laser (26) apparatus of claim 11, further comprising a vacuum box table (30) secured in fluid communication with the vacuum pump (36) so that the vacuum pump (36) applies a partial vacuum to a box (34) of the table (30), wherein the box (34) is dimensioned to receive and support the flat cutting surface (24) and seal it against fluid transfer into the box (34) other than through the throughbores (28).

13. The flat cutting surface (24) and laser (26) apparatus of claim 11, wherein the throughbores (28) are defined to be no greater than about one-sixteenth of an inch in diameter and are positioned no closer than about three-quarters on an inch from each other.

14. The flat cutting surface (24) and laser (26) apparatus of claim 11, wherein the flat cutting surface (24) is defined to have no variations within a plane of the flat cutting surface (24) that are greater than plus or minus about one hundredth of an inch.
